(19) United States
(12) Patent Application Publication
(10) Pub. No.: US 2014/0310061 A1
(43) Pub. Date: Oct. 16, 2014

(54) USING CROWDSOURCING FOR PROBLEM DETERMINATION

(71) Applicant: INTERNATIONAL BUSINESS MACHINES CORPORATION, Armonk, NY (US)

(72) Inventors: Mark A. Carmichael, Ball Ground, GA (US); Emi K. Olsson, Germantown, NY (US); Larisa Shwartz, Scarsdale, NY (US); Maja Vukovic, New York, NY (US)

(73) Assignee: INTERNATIONAL BUSINESS MACHINES CORPORATION, Armonk, NY (US)

(21) Appl. No.: 13/862,631

(22) Filed: Apr. 15, 2013

(51) Int. Cl. G06Q 30/02

(52) U.S. Cl. CPC G06Q 30/0203
USPC 705/7.32

(57) ABSTRACT

One embodiment of the invention, directed to a computer implemented method in a computer system comprising at least one component, includes the step of responsive to detecting a problem in the system, generating a set of crowdsourcing tasks for analyzing a first possible cause of the detected problem. The method further includes the steps of assigning the set of crowdsourcing tasks to one or more selected crowdsourcing experts, and using information derived at least in part from task results provided by one or more crowdsourcing experts to compute a problem completeness (PC) index. Responsive to determining that the first possible cause is not the root cause of the detected problem, the PC Index is used to determine whether to assign one or more additional crowdsourcing tasks to any crowdsourcing experts.

### BACKGROUND

1. Field

The invention disclosed and claimed herein generally pertains to a system and method wherein crowdsourcing is used, to determine the root cause of a problem in a computer network or system.

2. Description of the Related Art

Information technology (IT) problems in a computer network or other computer system are often quite complex, due to architectural dependencies on multiple system components. As a result, resolution of such problems may span several competencies, or types of expertise. Inability to locate the required expertise in a timely manner can slow down both problem resolution and associated root cause analysis (RCA). The necessary expertise, by way of example, could include local subject matter experts (SMEs), vendors, clients and the like.

Due to incorrect or missing root cause analysis, as well as effects of problems that have not been addressed, problems of the same type may continue to occur. Moreover, existing problem analysis and RCA methodologies, such as five Whys and the Kepner Troeger method, are insufficient to enforce SMEs to follow through and engage other team members. For example, currently available ISM and RCA tools lack such capabilities.

While crowdsourcing currently offers a low cost and efficient methodology for reaching out to targeted experts, tasks and requests are typically submitted to crowdsourcing marketplaces manually.

### SUMMARY

Embodiments of the invention are directed to a system and method that automatically generates crowdsourcing tasks, in order to execute a strategy driven problem determination process for uncovering the root cause of problems detected in a computer network or system. This process also engages multiple experts, and provides problem fix details. Through these embodiments, crowdsourcing problem determination methodology becomes a distributed process. Embodiments also provide a component that drives task contextualization (e.g. enhanced root cause analysis), and relies on a problem evaluation index to identify completeness of the problem determination record. Embodiments are characterized by a systematic approach to automated crowd task creation to facilitate problem determination, and by a generic approach that allows multiple, pluggable problem analysis methodologies. These embodiments make use of a dynamically evolving questionnaire, and a crowdsourcing campaign driven by a problem completeness index. The problem completeness index automatically evaluates the quality of a problem determination log and identifies gaps for follow up.

One embodiment of the invention, directed to a computer implemented method in a computer system comprising at least one component, includes the step of responsive to detecting a problem in the system, generating a set of crowdsourcing tasks for analyzing a first possible cause of the detected problem. The method further includes the steps of assigning the set of crowdsourcing tasks to one or more selected crowdsourcing experts, and using information derived at least in part from task results provided by one or more crowdsourcing experts to compute a problem completeness (PC) index. Responsive to determining that the first possible cause is not the root cause of the detected problem, the PC Index is used to determine whether to assign one or more additional crowdsourcing tasks to a crowdsourcing expert.

### BRIEF DESCRIPTION OF THE SEVERAL VIEWS OF THE DRAWINGS

FIG. 1 is a flowchart showing steps of a method comprising an embodiment of the invention.

FIGS. 2A and 2B together show a flowchart showing steps for generating problem analysis tasks to be assigned to crowdsourcing experts.

FIG. 3 is a schematic diagram depicting a formula for an exemplary problem completeness index for embodiments of the invention.

FIG. 4 is a flowchart showing steps for collecting, storing and using information to select crowdsourcing experts for respective tasks.

FIG. 5 is a flowchart showing steps of a process for assigning tasks to crowdsourcing experts.

FIG. 6 is a block diagram showing a network of data processing systems in which an embodiment of the invention may be implemented.

FIG. 7 is a block diagram showing a computer or data processing system that may be used in implementing embodiments of the invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

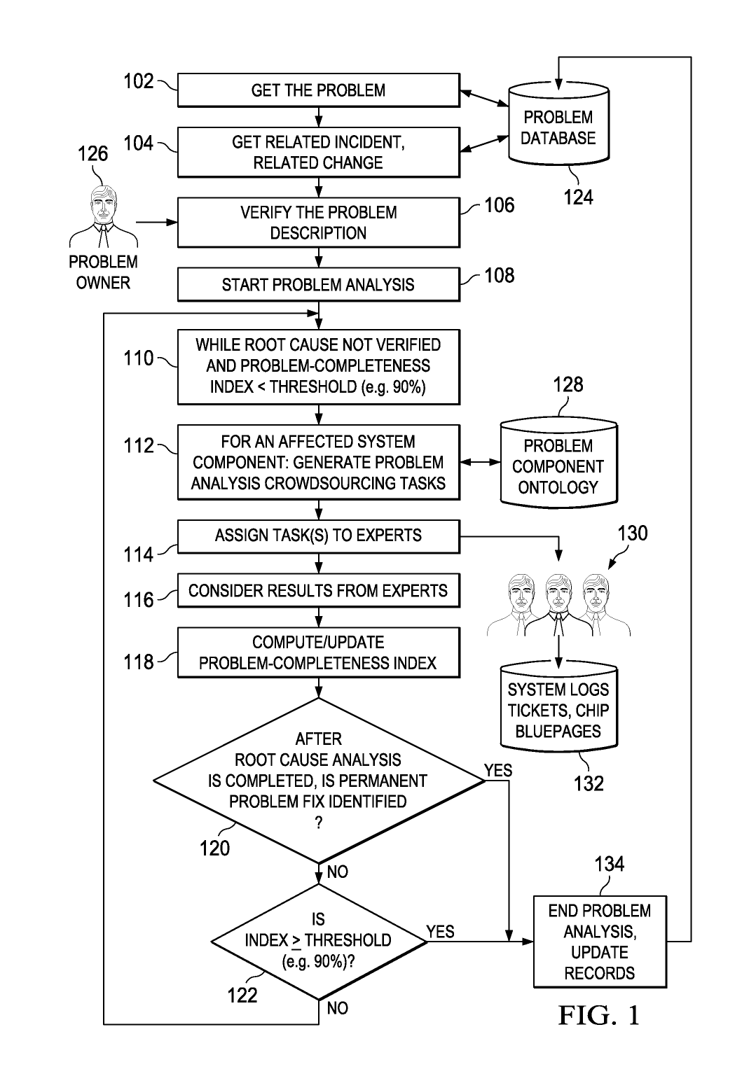

Referring to FIG. 1, there are shown steps of a method comprising an embodiment of the invention. Embodiments are intended to determine the root cause of a problem in computer systems, such as a computer network that has many components and extends across national boundaries. For example, a large scale center that delivers software or other computer-related services to multiple customers could have agreements that require it to quickly fix any service problems that occur, for all of the customers. However, such problems could require the expertise of multiple different technicians, including technicians who are widely separated from one another. Embodiments of the invention are well adapted to handle situations of this type, although the invention is by no means limited thereto.

It is to be understood that as used herein, the term “root-cause” refers to the particular cause of a problem in a computer system or network, wherein the problem is fixed permanently by correcting the particular cause, or by eliminating the particular cause or its effects.

As further benefits to a business, embodiments of the invention allow a problem owner to engage a customer, vendor or other organization team when they need assistance with determining the root cause of an issue, and/or the root cause of any contributing factors thereof, without requiring everyone to be available at one time for a phone call or messaging chat. If needed resources are located around the globe, it can often be difficult to get all of them together, because people are working various shifts. Thus, embodiments of the invention provide functionality that makes it much easier for a problem owner to get the information she or he needs, in order to document the root cause.

Step 102 of the method of FIG. 1 acquires a particular problem, such as a problem that has been detected in a computer system as described above. At step 104, an incident or change that is related to the problem may also be acquired, to enhance problem description. Both the particular problem and the related events of step 104 may be obtained from a problem database 124.

At step 106, a specific description of the particular problem is verified, by a problem owner 126. This step is provided to ensure that the particular problem is clearly defined, by one having a significant interest in problem resolution. An exemplary problem could be a mail server that doesn't work, and a problem description could be that the mail server doesn't work with a data base of a particular type. The problem owner by way of example could be the system administrator, or other representative of a system that has a component affected by the particular problem, such as a business process owner. At step 108, analysis of the problem is started.

Steps 110-122 of FIG. 1 together provide an iterative loop or cycle. More particularly, these steps act collectively to generate and assign crowdsourcing tasks, in order to obtain a diversity of expertise as needed, to deal with multiple different aspects of a particular problem. Thus, successive iterations of the crowdsourcing activity move progressively toward a correct determination of the root cause of the particular problem, so that the problem can be fixed. As is known by those of skill in the art, crowdsourcing is the act of outsourcing tasks, traditionally performed by an employee or contractor, to a large crowd, community or marketplace of people by means of an open call.

In addition, the steps 110-122 are involved in computing and updating a problem completeness index (PCI), which is matched against a threshold. The problem completeness index and threshold serve to apply a logical and practical limit to the crowdsourcing effort.

Referring further to FIG. 1, step 110 will commence the iterative loop only if two conditions are both met. These are that a root cause for the particular problem has not yet been verified, and the problem completeness index is less than the threshold value, which may be 90% by way of example. When both conditions are met, the method of FIG. 1 proceeds to step 112.

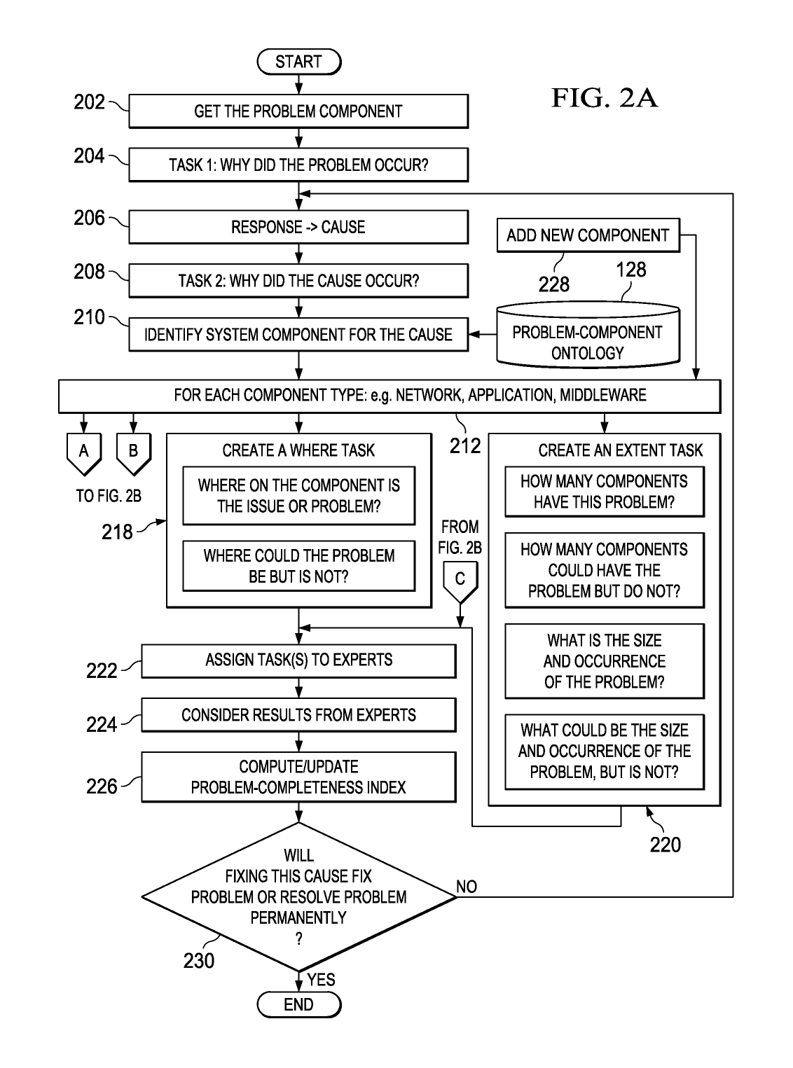

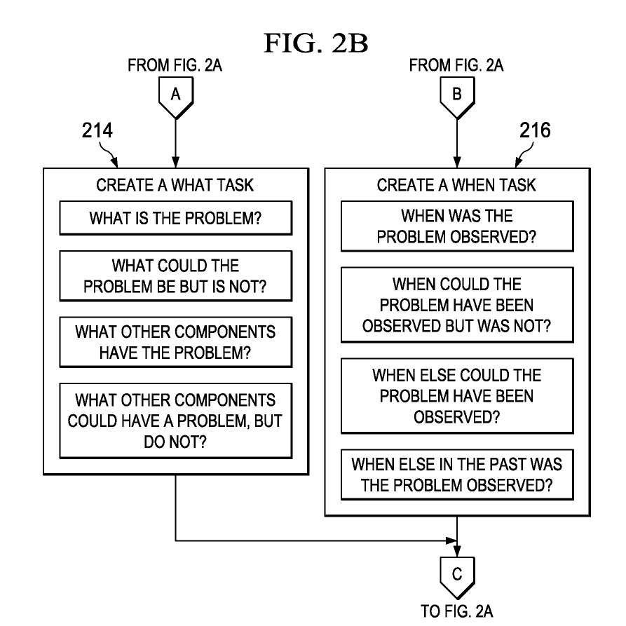

At step 112, crowdsourcing tasks are generated or created for carrying out an analysis of the particular problem, in order to determine the root cause thereof. More specifically, the crowdsourcing tasks are directed to an affected system component, which is a component associated with a possible cause of the particular problem. Hereinafter, in connection with FIG. 2, one exemplary crowdsourcing task creation procedure, which may be used to implement step 112 of FIG. 1, is described in further detail. This procedure may interact with an ontology 128, which contains a record of problem system components.

At step 114 the generated tasks are assigned to appropriate crowdsourcing experts 130. In carrying out the tasks, these experts may obtain relevant information from a database 132, such as system logs, maintenance tickets and blue pages.

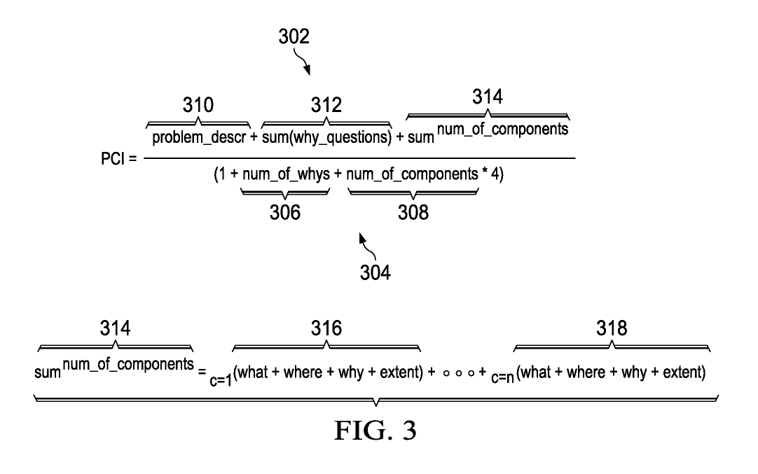

After the experts 130 complete their assigned tasks, and return their respective results to the task requester, the results are considered at step 116. At step 118, information provided at least in part by the task results is used to compute or update the problem completeness index. An exemplary procedure for computing the problem completeness index is described hereinafter in further detail, in connection with FIG. 3.

Decision step 120 queries whether the analysis provided by the results of the most recent crowdsourcing information has determined the root cause of the particular problem, and has thereby identified a permanent fix for the problem. If the query is positive, the method of FIG. 1 proceeds to step 134, which ends the analysis and concludes the method. Information pertaining to the conclusion is also used to update problem database 124.

If the query at step 120 is negative, the method proceeds to step 122. This step determines whether the problem completeness index is greater than or equal to the threshold. If this determination is affirmative, the method proceeds to step 134 and the method ends. However, if the determination is negative, the two conditions of step 110 discussed above are both met. Accordingly, the method proceeds to step 110, and another iteration of the steps 110-122 is commenced.

Referring to FIGS. 2A and 2B together, which are referred to collectively hereinafter as FIG. 2, there is shown a flowchart pertaining to creation and use of crowdsourcing tasks, for analysis of problems as described above. As further described above, the method or procedure of FIG. 2 may be readily used to implement step 112 of FIG. 1. At step 202 the procedure commences by acquiring a problem component, which could be the affected component of FIG. 1, or other component associated with a particular problem. For the above example of a mail server that wouldn't work with a particular database, the mail server could initially be selected as the problem component.

Step 204 specifies a “why” task, i.e., determining why the problem of the problem component occurred. At step 206, a response to the “why” task is provided, by proposing a cause for the component problem. This is followed by a further “why” task at step 208, which seeks to determine the reason why the cause has occurred. The “why” tasks 204 and 208 are also referenced as Tasks 1 and 2, respectively. Usefully, both of these tasks could be assigned to experts who would provide appropriate responses, in accordance with a crowdsourcing procedure.

At step 210 a system component is identified that is associated with or responsible for the cause determined at step 208. This component could be the initial problem component of step 202, or it could be a different component. Thus, for the mail server example, the particular database could be the identified system component. FIG. 2 shows that the component identification of step 210 may be assisted by information from problem component ontology 128.

At step 212, the system component identified at step 210, together with its associated possible problem cause, is selected for a thorough analysis by means of crowdsourcing. The analysis is carried out for each type of system component, including network, application and middleware components. The analysis requires creating a set of crowdsourcing tasks, which are carried out, respectively, at steps 214-220. More particularly, a What task is created at step 214; a When task is created at step 216; a Where task is created at step 218; and an Extent task is created at step 220.

Referring further to FIG. 2, it is shown that the What task of step 214 requires answering the questions what is the problem; what could be the problem but is not; what other components have the problem; and what other components could have a problem but do not?

The When task of step 216 requires answering the questions when was the problem observed; when could the problem have been observed but was not; when else could the problem have been observed; and when else in the past was the problem observed?

The Where task of step 218 requires answering the questions where on the component is the issue or problem; and where could the problem be but is not?

The Extent task of step 220 requires answering the questions how many components have the problem; how many components could have the problem but do not; what is the size and occurrence of the problem; and what could be the size and occurrence of the problem but is not?

At step 222 the tasks of steps 214-220, which respectively require providing answers to the above questions, are assigned to selected appropriate experts, using a crowdsourcing procedure. At step 224 the results or responses of respective experts are considered, and information furnished by these results may be used at step 226 to compute or update a problem completeness index. Thus, the steps 222, 224 and 226 are respectively similar to steps 114, 116 and 118 of FIG. 1. As a further effect of considering the results provided by experts, an additional component may be added for analysis at step 212, as shown by step 228.

At decision step 230, results provided by the crowdsourcing experts, in response to tasks pertaining to the system component and associated cause identified at step 210, are used to determine whether fixing that cause will permanently fix or resolve the particular problem. If the determination is affirmative, then such cause is identified as the root cause of the problem, and the procedure of FIG. 2 ends. Otherwise, the procedure returns to step 206, to select another possible cause of the particular problem. For the new possible cause, step 210 could identify either a new system component for analysis, or a component that was analyzed previously in connection with a different cause.

It will be appreciated that FIG. 2 illustrates a dynamic iterative procedure that can make use of crowdsourcing experts to successively analyze different system components and different possible causes of a particular system problem, in order to move toward identification of the root cause of the problem. While not shown in FIG. 2, it is anticipated that the iterative process thereof could be limited by applying a selected limit to the problem completeness index, as described above in connection with FIG. 1. The process could also continue until there are no more “why” questions to address.

FIG. 3 shows an exemplary problem completeness index (PCI) for embodiments of the invention, which comprises a numerator 302 and a denominator 304. Generally, the PCI provides a measure of the number of assigned tasks completed, against the complexity of the tasks that are assigned.

In the example of FIG. 2, each task comprises presentation of a question to a crowdsourcing expert, which must then be answered by the expert in order to complete the task. Some of these questions are the “why” questions of FIG. 2. Other questions are directed to one or more components of the system which is being analyzed. For each of these components, the What, When, Where and Extent questions, specified by steps 214-220, respectively, must each be answered by crowdsourcing experts.

For the procedure of FIG. 2, FIG. 3 shows denominator 304 of the PCI comprising the sum of 1 and components 306 and 308. Component 306 is the total number of “why” tasks, or “why” questions that are assigned to crowdsourcing experts in order to receive answers. Component 308 comprises the total number of system components to which the questions of steps 214-220 have been applied. Since these steps together specify a set of four questions for crowdsourcing experts, that is, the What, When, Where and Extent questions, component 308 of the denominator further comprises the total number of system components multiplied by a factor of 4.

Numerator 308 for the PCI comprises the sum of components 310, 312, and 314. Component 310 is directed to the problem description discussed above, in connection with step 106 of FIG. 1. If a specific description of the problem was verified, in accordance with step 106, component 310 is given a value of 1. Component 310 is otherwise equal to 0.

Component 312 is the total number of “why” question tasks that were assigned to crowdsourcing experts, and have been completed. A “why” question task is completed when the expert assigned to the task sends an appropriate answer back to the task requester. A value of 1 is awarded to component 312 for each completed task.

Component 314 is the total number of system component related tasks that were assigned to crowdsourcing experts, and have been completed. As described above, four tasks may be created for a system component, comprising the What, Where, Why and Extent questions. Each of these tasks is completed when the expert assigned the task sends an appropriate answer back to the task requester. A value of 1 is awarded to component 314 for each completed task.

To further illustrate component 314, FIG. 3 shows component 314 equal to the sum of components 316 and 318. Each of the components 316 and 318 represents the four question related tasks of a system component identified in FIG. 2, such as a system component c=1 or c=n.

After an iteration of a procedure such as that of FIG. 1or FIG. 2, it may be necessary to update the PCI of FIG. 3. For example, it may be necessary to increase the number of “why” questions assigned or completed, or the number of system component related questions that have been assigned or completed.

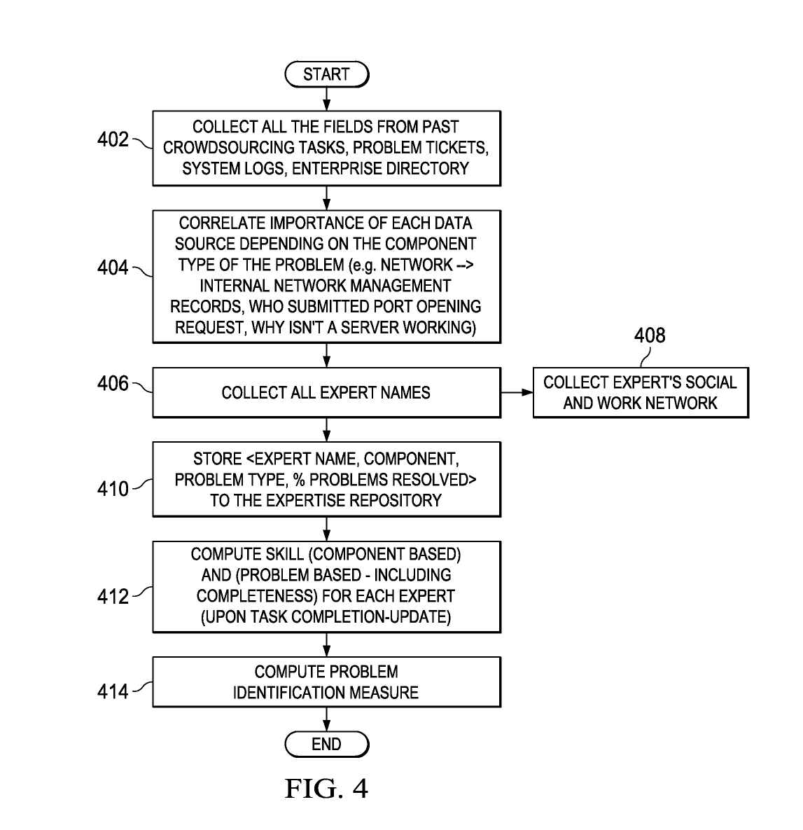

FIG. 4 is a flowchart showing steps for collecting, storing and using information to select crowdsourcing experts for tasks such as those described above in connection with FIGS. 1 and 2. At step 402, data is collected from sources such as all the fields from the past crowdsourcing tasks, problem tickets, system logs and enterprise directories.

Step 404 correlates the importance of each data source depending on the component type of the problem. For example, if the component type was a network, important data could include internal network management records, who submitted a port opening request, or who wanted to know why a server wasn't working.

At step 406, the names of pertinent experts are collected. Also, information for each of these experts could be collected from their social and work networks at step 408.

The name of each expert is stored to an expertise repository at step 410. The system components and problem types that an expert has worked with are stored with the name of that expert, together with the percentage of problems the expert has resolved.

At step 412 the component based and problem-based skill of the expert is computed, based on information of the type described above, including tasks previously completed by the expert. This computation is updated when the expert completes a further task.

From the information of preceding steps, a problem identification measure is computed for each expert at step 414. The measure may be used in selecting the experts who will be assigned tasks of a specified type.

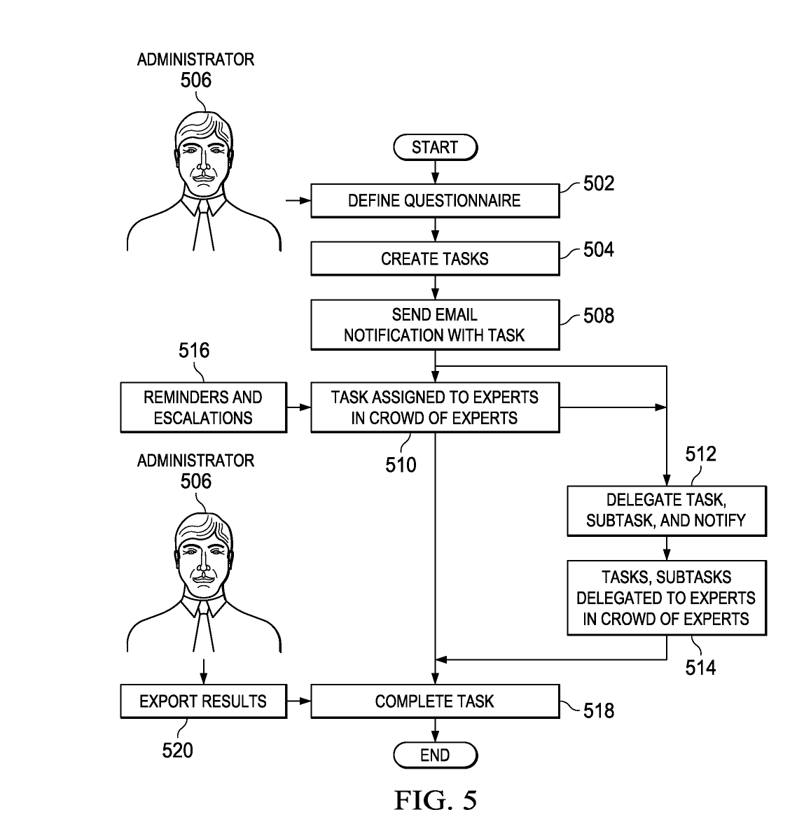

Referring to FIG. 5, there are shown steps of a method or procedure for assigning tasks of the type described above for crowdsourcing, in accordance with embodiments of the invention. At step 502, a questionnaire is defined that pertains to a particular problem in a computer system. The questionnaire is directed to a set of “why” questions and system component analysis questions, as described above in connection with FIG. 2. Step 502 may be carried out, for example, by a crowdsourcing administrator 506 or the like.

At step 504, the crowdsourcing tasks are created, wherein a task can comprise preparation of the questionnaire associated with a problem owner. One instance or example of a set of questions for a questionnaire could be the following:
X.1 Why did the cause of the problem occur?
X.2 If the above cause is fixed, will it permanently prevent this problem or issue from ever happening again?
If your answer to question X.2 is Yes:
   Describe in detail why the fix is permanent.
   What steps need to be taken to apply the necessary fix?
   Who needs to perform these steps?
If your answer to question X.2 is No:
   Why won't the fix permanently prevent the problem from happening again?
   What steps are necessary to fix the above cause as a contributing factor?
   Who needs to perform these steps?

It will be appreciated that a questionnaire of the above type can evolve dynamically. For example, for each successive iteration as described above in connection with FIG. 1 or FIG. 2, the questionnaire can be updated or modified as required.

At step 508, tasks comprising questionnaires as described above, together with appropriate notification, are sent by email or the like to a crowd or community of experts. These are experts who are very knowledgeable about the subject matter to which respective tasks pertain. At step 510, tasks are assigned to certain experts selected from the crowd of experts.

At step 512, decisions are made to delegate some of the tasks, or subtasks thereof, to experts other than experts selected at step 510. These decisions may be made directly in the assignment of tasks, or could be made by some of the selected experts. Delegated tasks and subtasks are assigned to experts in a crowd of experts at step 514.

At step 516, reminders to complete tasks and escalations thereof, are respectively sent as required to experts who have been assigned tasks.

At step 518, respective tasks are completed. The administrator 506, at step 520, provides information that indicates what is to be done with respective task results.

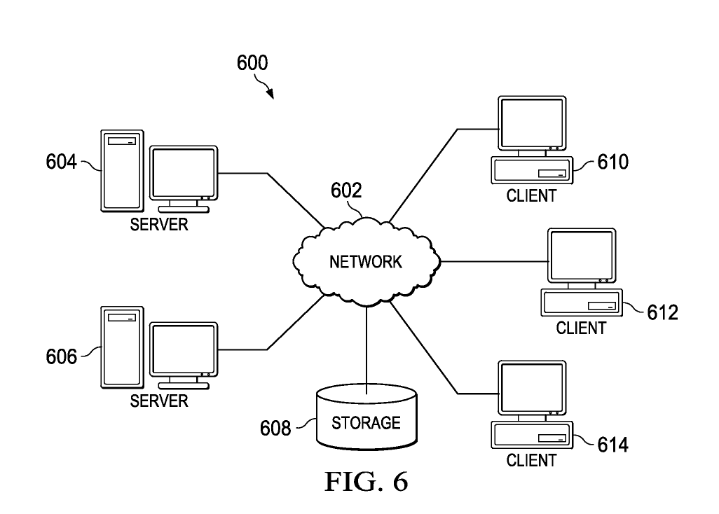

FIG. 6 is a pictorial representation of a network of data processing systems in which illustrative embodiments of the invention may be implemented. Network data processing system 600 is a network of computers in which the illustrative embodiments may be implemented. Network data processing system 600 contains network 602, which is the medium used to provide communications links between various devices and computers connected together within network data processing system 600. Network 602 may include connections, such as wire, wireless communication links, or fiber optic cables.

In the depicted example, server computer 604 and server computer 606 connect to network 602 along with storage unit 608. In addition, client computers 610, 612, and 614 connect to network 602. Client computers 610, 612, and 614 may be, for example, personal computers or network computers. In the depicted example, server computer 604 provides information, such as boot files, operating system images, and applications to client computers 610, 612, and 614. Client computers 610, 612, and 614 are clients to server computer 604 in this example. Network data processing system 600 may include additional server computers, client computers, and other devices not shown.

Program code located in network data processing system 600 may be stored on a computer-recordable storage medium and downloaded to a data processing system or other device for use. For example, program code may be stored on a computer-recordable storage medium on server computer 604 and downloaded to client computer 610 over network 602 for use on client computer 610.

In the depicted example, network data processing system 600 is the Internet with network 602 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational and other computer systems that route data and messages. Of course, network data processing system 600 also may be implemented as a number of different types of networks, such as, for example, an intranet, a local area network (LAN), or a wide area network (WAN). FIG. 6 is intended as an example, and not as an architectural limitation for the different illustrative embodiments.

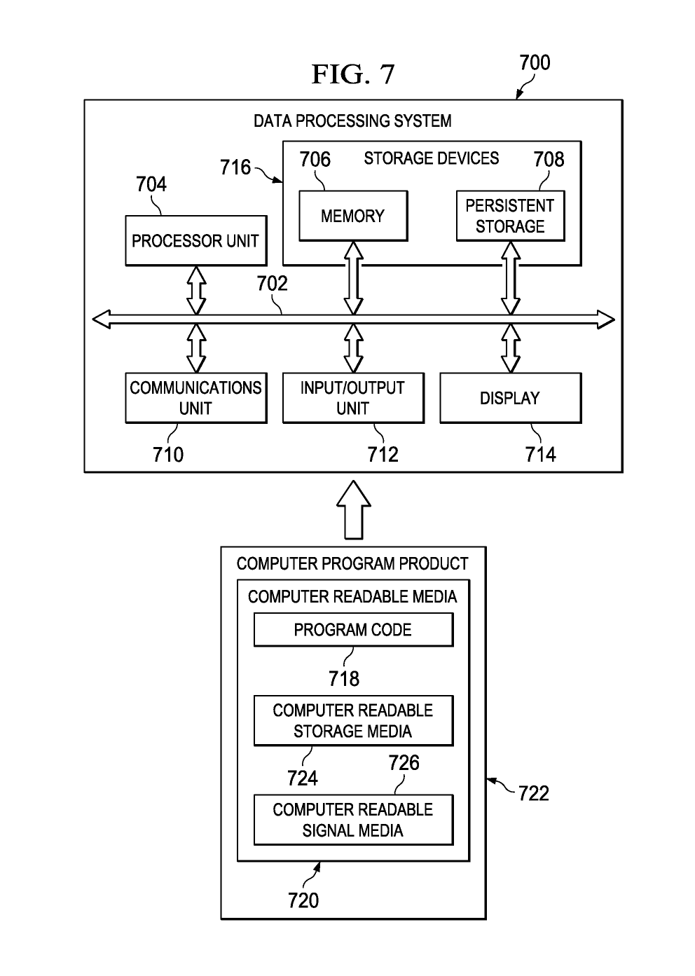

Turning now to FIG. 7, an illustration of a data processing system is depicted in accordance with an illustrative embodiment. In this illustrative example, data processing system 700 includes communications fabric 702, which provides communications between processor unit 704, memory 706, persistent storage 708, communications unit 710, input/output (I/O) unit 712, and display 714.

Processor unit 704 serves to process instructions for software that may be loaded into memory 706. Processor unit 704 may be a number of processors, a multi-processor core, or some other type of processor, depending on the particular implementation. “A number,” as used herein with reference to an item, means one or more items. Further, processor unit 704 may be implemented using a number of heterogeneous processor systems in which a main processor is present with secondary processors on a single chip. As another illustrative example, processor unit 704 may be a symmetric multi-processor system containing multiple processors of the same type.

Memory 706 and persistent storage 708 are examples of storage devices 716. A storage device is any piece of hardware that is capable of storing information, such as, for example, without limitation, data, program code in functional form, and/or other suitable information either on a temporary basis and/or a permanent basis. Storage devices 716 may also be referred to as computer readable storage devices in these examples. Memory 706, in these examples, may be, for example, a random access memory or any other suitable volatile or non-volatile storage device. Persistent storage 708 may take various forms, depending on the particular implementation.

For example, persistent storage 708 may contain one or more components or devices. For example, persistent storage 708 may be a hard drive, a flash memory, a rewritable optical disk, a rewritable magnetic tape, or some combination of the above. The media used by persistent storage 708 also may be removable. For example, a removable hard drive may be used for persistent storage 708.

Communications unit 710, in these examples, provides for communications with other data processing systems or devices. In these examples, communications unit 710 is a network interface card. Communications unit 710 may provide communications through the use of either or both physical and wireless communications links.

Input/output unit 712 allows for input and output of data with other devices that may be connected to data processing system 700. For example, input/output unit 712 may provide a connection for user input through a keyboard, a mouse, and/or some other suitable input device. Further, input/output unit 712 may send output to a printer. Display 714 provides a mechanism to display information to a user.

Instructions for the operating system, applications, and/or programs may be located in storage devices 716, which are in communication with processor unit 704 through communications fabric 702. In these illustrative examples, the instructions are in a functional form on persistent storage 708. These instructions may be loaded into memory 706 for processing by processor unit 704. The processes of the different embodiments may be performed by processor unit 704 using computer-implemented instructions, which may be located in a memory, such as memory 706.

These instructions are referred to as program code, computer usable program code, or computer readable program code that may be read and processed by a processor in processor unit 704. The program code in the different embodiments may be embodied on different physical or computer readable storage media, such as memory 706 or persistent storage 708.

Program code 718 is located in a functional form on computer readable media 720 that is selectively removable and may be loaded onto or transferred to data processing system 700 for processing by processor unit 704. Program code 718 and computer readable media 720 form computer program product 722 in these examples. In one example, computer readable media 720 may be computer readable storage media 724 or computer readable signal media 726.

Computer readable storage media 724 may include, for example, an optical or magnetic disk that is inserted or placed into a drive or other device that is part of persistent storage 708 for transfer onto a storage device, such as a hard drive, that is part of persistent storage 708. Computer readable storage media 724 also may take the form of a persistent storage, such as a hard drive, a thumb drive, or a flash memory, that is connected to data processing system 700.

In some instances, computer readable storage media 724 may not be removable from data processing system 700. In these examples, computer readable storage media 724 is a physical or tangible storage device used to store program code 718 rather than a medium that propagates or transmits program code 718. Computer readable storage media 724 is also referred to as a computer readable tangible storage device or a computer readable physical storage device. In other words, computer readable storage media 724 is media that can be touched by a person.

Alternatively, program code 718 may be transferred to data processing system 700 using computer readable signal media 726. Computer readable signal media 726 may be, for example, a propagated data signal containing program code 718. For example, computer readable signal media 726 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 718 may be downloaded over a network to persistent storage 708 from another device or data processing system through computer readable signal media 726 for use within data processing system 700. For instance, program code stored in a computer readable storage medium in a server data processing system may be downloaded over a network from the server to data processing system 700. The data processing system providing program code 718 may be a server computer, a client computer, a remote data processing system, or some other device capable of storing and transmitting program code 718. For example, program code stored in the computer readable storage medium in data processing system 700 may be downloaded over a network from the remote data processing system to the computer readable storage medium in data processing system 700. Additionally, program code stored in the computer readable storage medium in the server computer may be downloaded over the network from the server computer to a computer readable storage medium in the remote data processing system.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. In a computer system comprising at least one component, a computer implemented method comprising the steps of:
responsive to detecting a problem in the system, generating a set of crowdsourcing tasks for analyzing a first possible cause of the detected problem;
assigning the set of crowdsourcing tasks to one or more selected crowdsourcing experts;
using information derived at least in part from task results provided by one or more crowdsourcing experts to compute a problem completeness (PC) index; and
responsive to determining that the first possible cause is not the root cause of the detected problem, using the PC index to determine whether to assign one or more additional crowdsourcing tasks to a crowdsourcing expert.

2. The method of claim 1, wherein:
an iterative procedure is used in an analysis to determine whether a given possible cause is the root cause of the detected problem, wherein a cycle of the iterative procedure includes a first task of determining why the given cause occurred.

3. The method of claim 2, wherein:
the computer system comprises multiple components, and a cycle of the iterative procedure includes one or more second tasks, wherein each second task obtains information of a specified type which pertains to a component associated with the given cause.

4. The method of claim 3, wherein:
one or more of the first and second tasks is each selected to be implemented by generating a questionnaire, wherein each questionnaire contains one or more questions associated with at least one of the selected tasks.

5. The method of claim 3, wherein:
the first and second tasks are respectively included in the set of crowdsourcing tasks, and are each assigned to a selected crowdsourcing expert.

6. The method of claim 5, wherein:
the crowdsourcing expert assigned to a given first or second task completes the given task by furnishing information requested by a questionnaire associated with the given task.

7. The method of claim 1, wherein:
generating a set of crowdsourcing tasks comprises generating questionnaires that include questions pertaining to the detected problem, to a possible cause of the detected problem, and to system components associated with the detected problem or possible cause, selectively.

8. The method of claim 7, wherein:
generating the set of crowdsourcing task is implemented by an iterative procedure, and a questionnaire is selectively modified following a cycle of the iterative procedure.

9. The method of claim 1, wherein:
the PC index comprises a specified relationship between completed crowdsourcing tasks, and a complexity of implementing respective tasks.

10. The method of claim 1, wherein:
the PC index is selectively updated, as respective crowdsourcing tasks are completed.

11. The method of claim 1, wherein:
a database of crowdsourcing experts is selectively maintained.

12. The method of claim 1, wherein:
the implemented method ends when either a root cause of the detected problem is determined, or the PC index exceeds a prespecified threshold value.

13-19. (canceled)

20. In a computer system comprising at least one component, a computer implemented method comprising the steps of:
receiving a request to implement a determination service, which requires determining specified information;
responsive to receiving the request, carrying out an analysis to determine a set of tasks that must be performed in order to determine the specified information;
assigning each task of the set of tasks to one or more selected crowdsourcing experts;
using information derived at least in part from task results provided by one or more crowdsourcing experts to compute an information completeness index; and
responsive to determining that the specified information has not been determined, using the index to determine whether to assign one or more additional crowdsourcing tasks to a crowdsourcing expert.
